(19) United States
(12) Patent Application Publication
(10) Pub. No.: US 2007/0054544 A1
(43) Pub. Date: Mar. 8, 2007

(54) Holder for flat flexible circuitry

(76) Inventor: Toshihisa Hirata, Yamato-shi (JP)

Correspondence Address: MOLEX INCORPORATED, 2222 WELLINGTON COURT, LISLE, IL, 60532, US

(21) Appl. No.: 11/221,212

(22) Filed: Sep. 7, 2005

(51) Int. Cl. H01R 12/24

(52) U.S. Cl. 439/495

(57) ABSTRACT

The disclosure describes a holder for attachment to a distal end portion of a flat flexible cable (FFC) and directly engaging exposed conductors of the FFC with appropriate terminals of a mating connector. The FFC has opposite side edges and opposite flat surfaces between the side edges. The holder includes a pair of interengaging gripping members for gripping the opposite flat surfaces of the FFC between the opposite side edges thereof. A latch is provided on at least one of the gripping members for latching the holder to the mating connector, with the exposed conductors of the FFC in direct engagement with the terminals of the mating connector.

### FIELD OF THE INVENTION

This invention generally relates to the art of electrical connectors and, particularly, to a holder for interconnecting or terminating flat flexible circuitry.

### BACKGROUND OF THE INVENTION

A flat flexible circuit or cable conventionally includes an elongated flat flexible dielectric substrate having laterally spaced strips of conductors on one or both sides thereof. The conductors often are covered with a thin, flexible protective layer on one or both sides of the circuit. If protective layers are used, the layers are stripped or cutouts are formed therein to expose the underlying conductors where the conductors are to engage the conductors or terminals of a complementary mating connecting device which may be a second flat flexible circuit, a printed circuit board or the terminals of a mating connector. The flat flexible circuit may be a flat flexible cable, a flexible printed circuit board or the like. Hereinafter, such circuitry will be referred to as a flat flexible cable (“FFC”).

Problems often are encountered in connecting or terminating an FFC because of its low rigidity. If a bare FFC is inserted into a mating connector, insertion resistance often causes deformation or inadequate insertion of the FFC. In order to solve this problem, zero-insertion force (ZIF) connectors have been designed. After insertion of an FFC into a ZIF connector, an actuator is moved to press the FFC against the connector terminals. Unfortunately, such ZIF connectors are unduly complex and excessively large in size.

An example of a non-ZIF connector is shown in Japanese Patent Application Laid-Open No. 2002-124321, wherein a lock member is attached to a distal end portion of the FFC and is adapted to be engaged by the non-ZIF connector to lock the connector and the FFC in engagement. Such lock members are adapted to support solely the side edges of the FFC. In other words, a greater portion of the FFC (i.e., between its side edges) is not supported by the lock member and therefore remains flexible and unstable. A metallic reinforcement sheet often is laminated to the FFC. The metallic sheet may have a shield function and is usually thin and does into have sufficient strength to prevent deformation of the FFC. If a thick metallic reinforcement sheet of sufficient strength is used, the weight increases significantly with resulting difficulty in handling, and there is a significant cost increase. The present invention is directed to solving this myriad of problems.

### SUMMARY OF THE INVENTION

An object, therefore, of the invention is to provide a new and improved holder for an FFC to facilitate interconnecting or terminating the FFC.

Another object of the invention is to provide an electrical connector assembly for terminating an FFC utilizing the holder of the invention.

In the exemplary embodiment of the invention, a holder is provided for attachment to a distal end portion of a flat flexible cable (FFC) for and directly engaging exposed conductors of the FFC with appropriate terminals of a mating connector. The FFC has opposite side edges and opposite flat surfaces between the side edges. The holder includes a pair of interengaging gripping members for gripping the opposite flat surfaces of the FFC between the opposite side edges thereof. Latch means are provided on at least one of the gripping members for latching the holder to the mating connector, with the exposed conductors of the FFC in direct engagement with the terminals of the mating connector.

According to one aspect of the invention, at least one of the gripping members includes positioning means for properly positioning the distal end portion of the FFC in the holder. As disclosed herein, the positioning means is provided by a positioning post on the one gripping member for insertion into a positioning hole in the FFC. Preferably, a pair of the positioning posts are laterally spaced for insertion into a pair of the positioning holes near the opposite side edges of the FFC. The other of the gripping member includes a pair of positioning recesses for accommodating the positioning posts of the one gripping member.

According to another aspect of the invention, at least one of the gripping members includes a plurality of gripping projections in an array extending between the opposite side edges of the FFC and grippingly engageable with one flat surface of the FFC. The other gripping member includes a flat face engageable with the other flat surface of the FFC behind the gripping projections.

According to a further aspect of the invention, latch means are provided between the two gripping members to hold the gripping members against the opposite flat surfaces of the FFC. As disclosed herein, the interengaging latch means is provided by a snap-latch means for automatically latching the gripping members together by pressing the gripping members against the opposite flat surfaces of the FFC.

Other features of the invention include the distal end portion of the FFC having a leading edge, and one of the gripping members includes a lip extending over the leading edge to protect the leading edge.

The invention also contemplates an electrical connector assembly for terminating an FFC. The assembly includes a connector along with a cable holder as described above.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector assembly including a first embodiment of a connector and a cable holder insertable into the connector, according to the invention;

FIG. 2 is a perspective view of the assembly of FIG. 1, in assembled condition;

FIGS. 3(a), (b) and (c) are front, top and side elevational views, respectively, of the cable holder according to the first embodiment;

FIG. 4 is a sectional view through a pair of cable holders at opposite distal ends of an FFC;

FIG. 5 is an exploded perspective view of the cable holder, including a pair of gripping members with the distal end portion of the FFC therebetween;

FIG. 6 is a view similar to that of FIG. 5, but taken in the opposite direction;

FIGS. 7-9 are sequential views of assembling the FFC within the cable holder;

FIGS. 10-14 are different versions of the cable holder, in relation to the area of the holder at the leading edge of the FFC;

FIG. 15(a), (b) and (c) are top, front and side elevational views, respectively, of the connector in FIGS. 1 and 2;

FIG. 16 is an enlarged vertical section taken generally along line 16-16 in FIG. 15(b);

FIG. 17 is a view similar to that of FIG. 16, with the connector mounted on a printed circuit board and with the cable holder about to be inserted into the connector;

FIG. 18 is a view similar to that of FIG. 17, with the cable holder and FFC inserted into the connector;

FIG. 19(a), (b) and (c) are views similar to that of FIG. 15(a), (b) and (c), respectively, but of a second embodiment of the connector;

FIG. 20 is an enlarged vertical section taken generally along line 20-20 in FIG. 19(b); and

FIGS. 21 and 22 are views similar to that of FIGS. 17 and 18, respectively, but of the second embodiment.

### DETAILED DESCRIPTION OF THE PREFERRED EMBODIMENTS

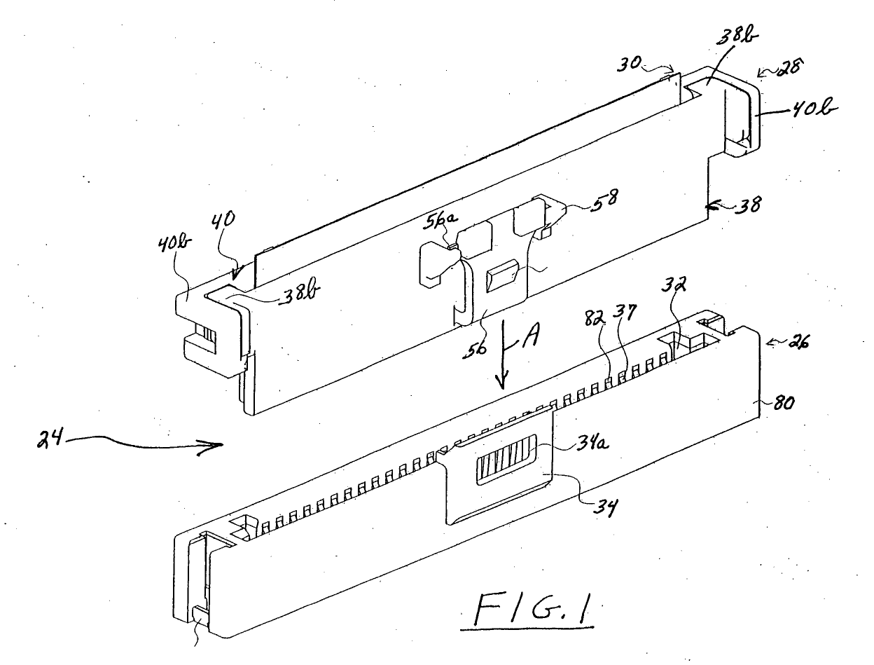

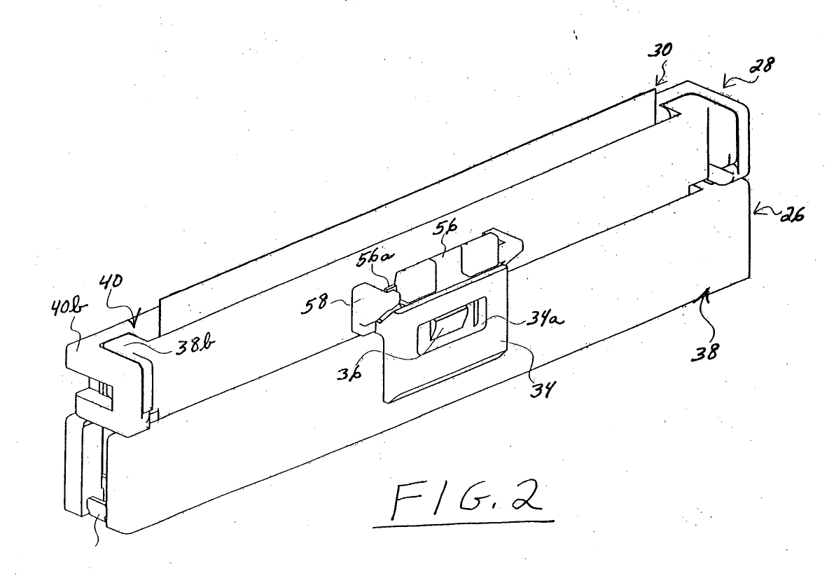

Referring to the drawings in greater detail, and first to FIGS. 1 and 2, the invention is embodied in an electrical connector assembly, generally designated 24, which includes a first embodiment of a connector, generally designated 26, for receiving a cable holder, generally designated 28, which is attached to a distal end portion of a flat flexible cable (“FFC”), generally designated 30. After the FFC is attached to the holder, the holder and FFC are inserted into a receptacle 32 in the connector in the direction of arrow “A” (FIG. 1). The connector has a latch 34 with a latch aperture 34a for receiving a chamfered latch boss 36 on the holder to latch the holder to the connector as seen in FIG. 2. When the holder and FFC are fully inserted into the connector, exposed conductors (described hereinafter) on the FFC will engage terminals 37 (FIG. 1) exposed within receptacle 32 of connector 26.

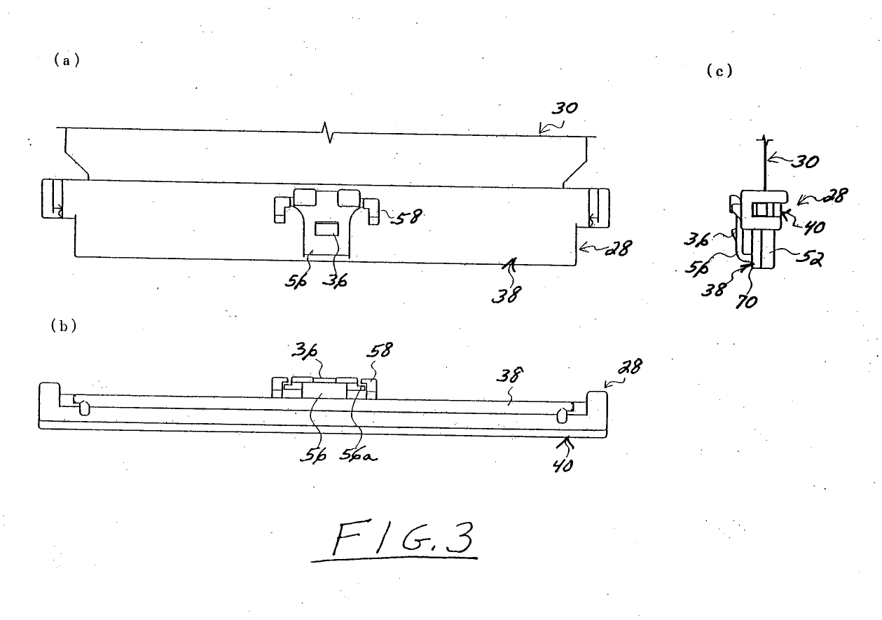

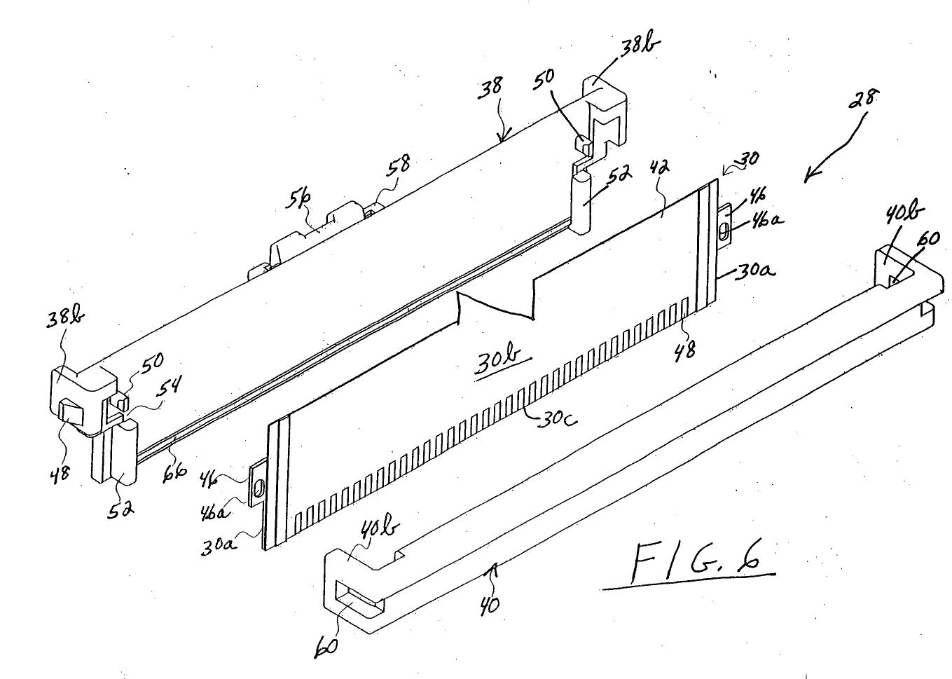

Referring to FIGS. 3, 5 and 6 in conjunction with FIGS. 1 and 2, cable holder 28 includes a pair of gripping members, generally designated 38 and 40, which grip or clamp FFC 30 therebetween. Before proceeding with a description of the details of the gripping members, the drawings show only a distal end portion of the FFC which includes opposite side edges 30a and opposite flat surfaces 30b. The FFC includes an elongated flat flexible dielectric substrate 42 and a reinforcing film 44. A tab 46 projects outwardly from each opposite side edge 30a of the FFC, and a positioning hole 46a is formed in each tab. Tabs 46 could be eliminated, and positioning holes 46a could be formed inside edges 30a of the FFC. As is known in the art, the FFC includes laterally spaced strips of conductors, and the conductors are exposed, as at 40a (FIG. 6), for engaging terminals 38 (FIG. 1) of connector 26. The exposed conductors 40a extend along a leading edge 30c of FFC 30, and the exposed conductors are spaced at a selected pitch, such as on the order of 1.0 mm. Reinforcing film 44 may provide a shield to prevent generation of noise.

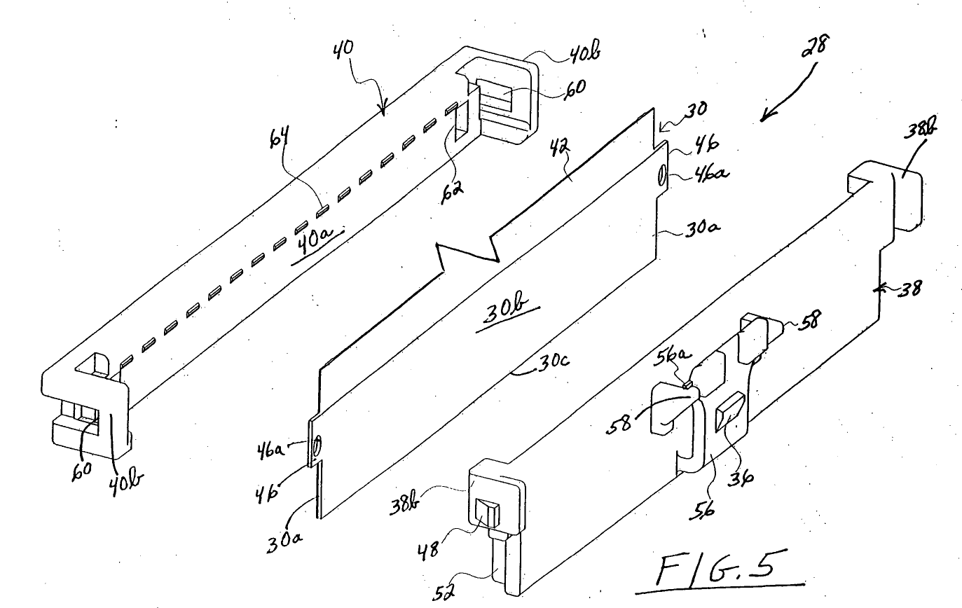

Gripping member 38 of cable holder 28 is a substantially rectangular plate member extending the entire width of FFC 30 and including a flat face 38a (FIG. 6) which faces the FFC. Gripping member 38 includes a pair of side wings 38b having chamfered latch bosses 48 projecting outwardly therefrom. A pair of positioning posts 50 project inwardly from flat face 38a immediately inside side wings 38b. A pair of side walls 52 also project inwardly from flat face 38a beneath positioning posts 50 and define spaces 54 therebetween. Latch boss 36 projects outwardly from a flexible latch arm 56 as best seen in FIG. 5. The latch arm has a pair of restraining protrusions 56a which engage a pair of restraining members 58 to prevent outward over-stressing of the latch arm.

Still referring to FIGS. 5 and 6 in conjunction with FIGS. 1-3, gripping member 40 has a flat face 40a which faces FFC 30 and a pair of side wings 40b. The side wings have latch apertures 60 for latchingly engaging the chamfered latch bosses 48 of gripping member 38. A pair of holes or recesses 62 are formed in gripping member 40 immediately inside the side wings 40b for accommodating positioning posts 50 of gripping member 38. Finally, a plurality of gripping projections 64 (FIG. 5) extend in an array (straight line) between side wings 40b and, therefore, between the opposite side edges 30a of FFC 30. In essence, gripping projections 64 of gripping member 40 point toward flat face 38a of gripping member 38.

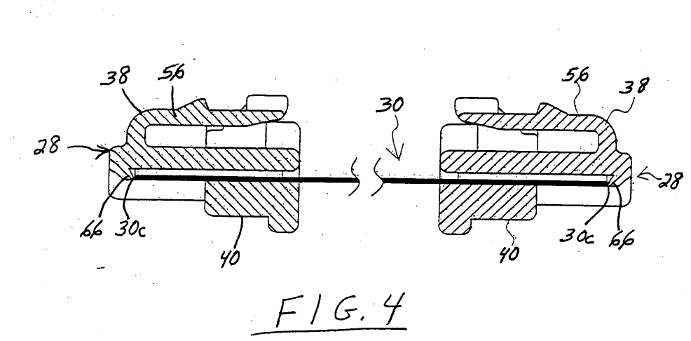

FIG. 4 simply shows a pair of cable holders 28 attached to opposite distal end portions of an elongated FFC 30. Each holder 28 includes a pair of gripping members 38 and 40 as described above to grip the distal end portions of the FFC within the two holders. In these sectional views, it can be seen that each gripping member 38 of each holder 28 includes a lip 66 which extends over the leading edges 30c of the FFC to protect the leading edges. This protective lip can be seen in FIG. 6.

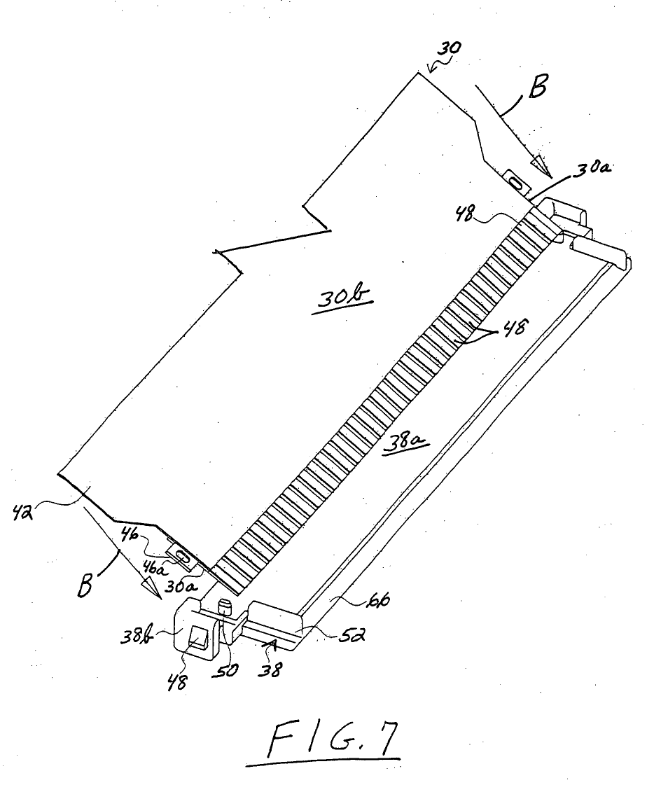

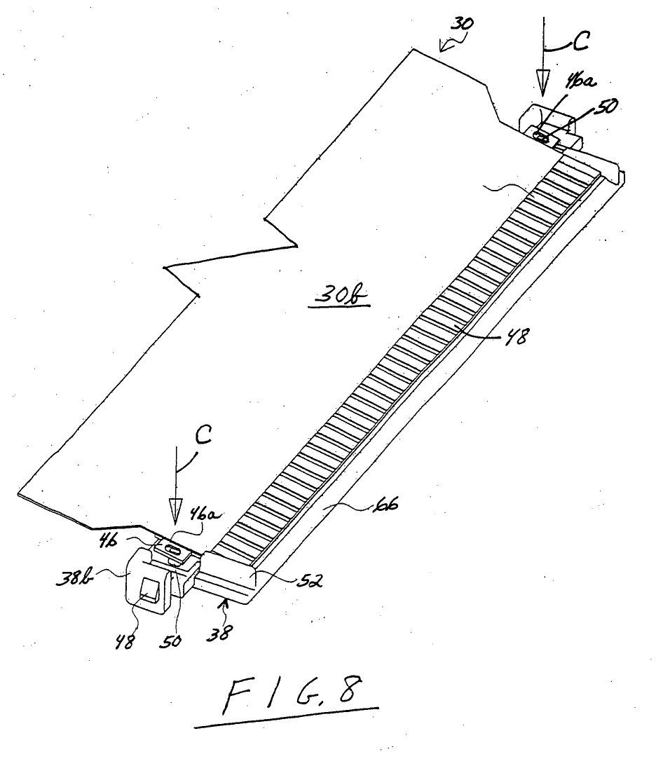

FIGS. 7-9 show FFC 30 being assembled within cable holder 38 as described above. The distal end 30c of FFC 30 is slidably moved in the direction of arrows “B” (FIG. 7) into engagement with flat face 38a of gripping member 38 until the leading edge abuts against protective lip 66 as seen in FIG. 8. The FFC then is pivoted downwardly in the direction of arrows “C” (FIG. 8) to move positioning holes 46a over positioning posts 50 which project from flat face 38a of gripping member 38. The other gripping member 40 then is moved in the direction of arrows “D” (FIG. 9) until latch apertures 60 in side wings 40b of gripping member 40 snap into latching engagement about the chamfered latch bosses 48 of gripping member 38. The cable holder and attached FFC then are ready to be inserted in the direction of arrow “A” (FIG. 1) into receptacle 32 of connector 26.

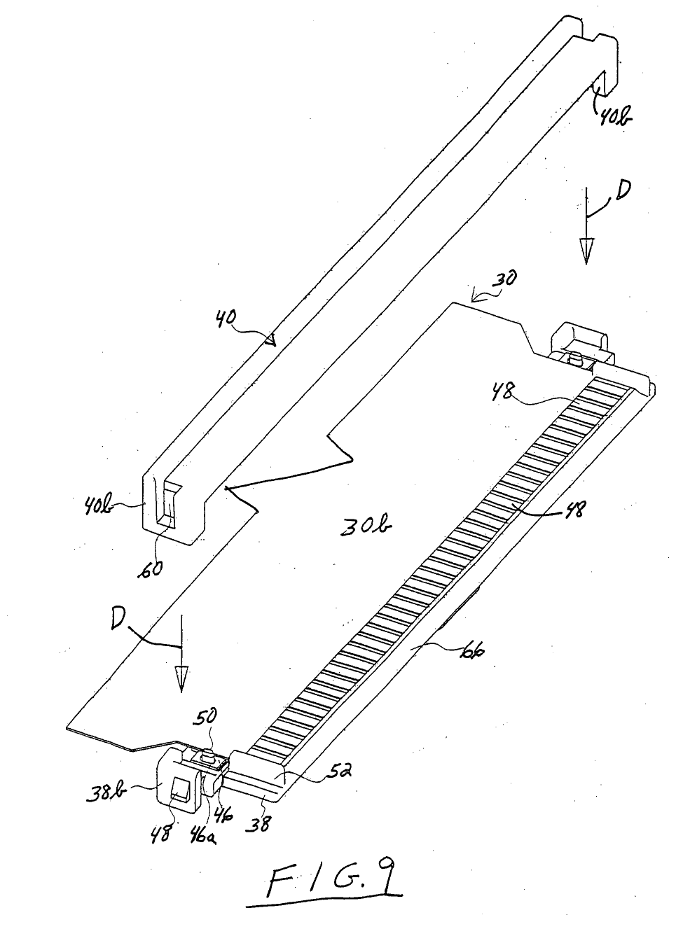

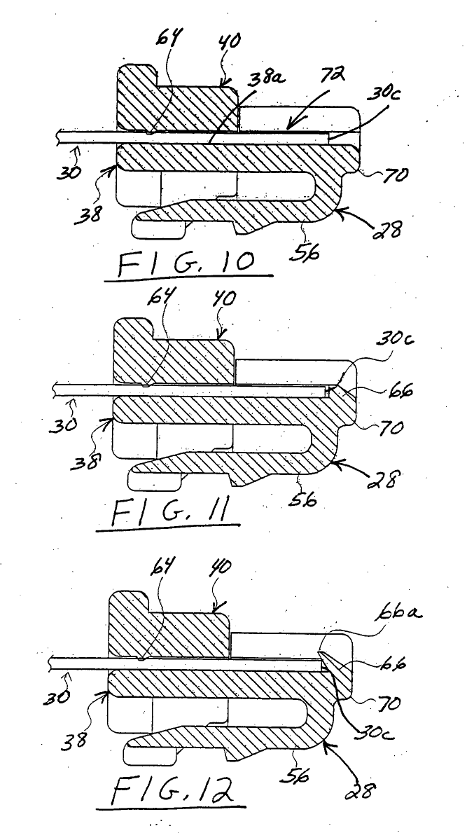

FIGS. 10-14 show various versions of cable holder 28 in the area of the leading edge 30c of FFC 30. FIG. 10 shows that a distal end 70 of gripping member 38 projects beyond leading edge 30c of the FFC. This provides some protection for the leading edge of the FFC. FIG. 10 shows how griping projections 64 of gripping member 40 positively engage the FFC as the FFC is backed by flat face 38a of gripping member 38. The conductors 48 of the FFC also are exposed in an area generally indicated at 72 in FIG. 10 for engaging terminals 37 of connector 26. In other words, gripping member 40 does not cover the exposed conductors. Distal end 70 of gripping member 38 is rounded to provide for smooth insertion of holder 28 into the receptacle of connector 26.

FIG. 11 shows a version wherein protective lip 66 on gripping member 38 extends over leading edge 30c of FFC 30. This protective lip prevents the leading edge of the FFC from “stubbing” on any extraneous objects, including portions of connector 26, when cable holder 28 is handled or inserted into the connector.

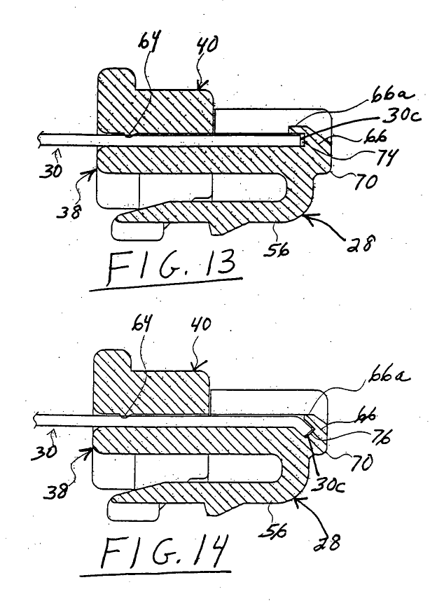

FIG. 12 shows a version wherein a distal end or edge 66a of protective lip 66 extends completely beyond the exposed surface of FFC 30. This adds additional protection for the FFC including leading edge 30c.

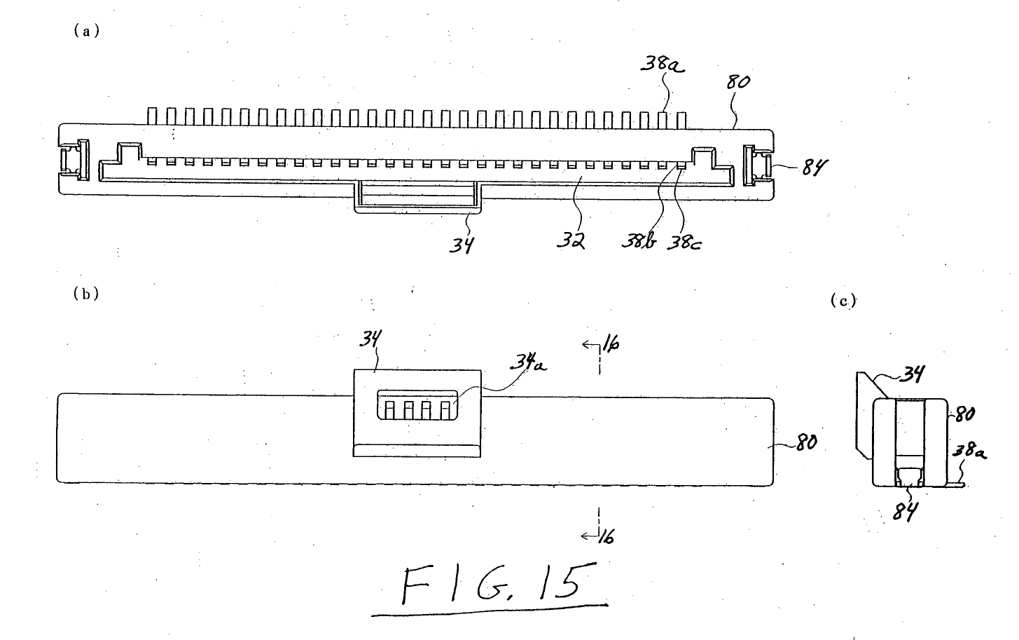

FIG. 13 shows another version wherein distal edge 66a of protective lip 66 extends over the surface of FFC 30 to actually form a groove 74 which encapsulates the extreme end of the FFC along leading edge 30c. This provides further assurance that the leading edge of the FFC will not abut or stub onto extraneous objects such as the terminals of connector 26.

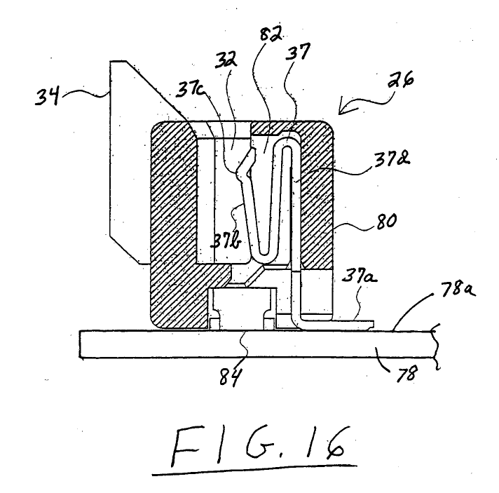

FIG. 14 shows still another version wherein protective lip 76 forms an angled groove 76 for receiving leading edge 30c of the FFC. With groove 76 being at an angle, distal edge 66a of protective lip 66 does not project beyond the flat surface of the FFC.

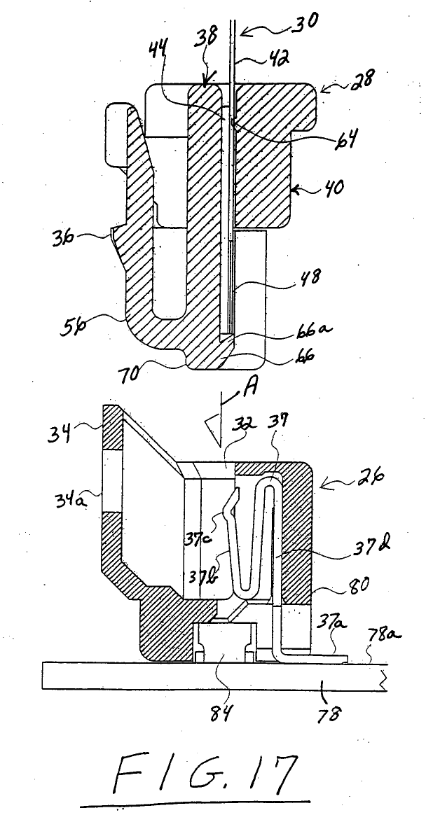

Referring to FIGS. 15 and 16 in conjunction with FIGS. 1 and 2, connector 26 is designed for mounting on a surface 78a of a printed circuit board 78 (FIG. 16). The connector includes a dielectric housing 80 mounting terminals 37 within a plurality of terminal-receiving passages 82 in the housing. A pair of metal fitting nails 84 are mounted on the housing and are secured, as by soldering, to appropriate mounting pads on the circuit board. As best seen in FIG. 16, each terminal 37 includes a tail portion 37a for connection, as by soldering, to an appropriate circuit trace on surface 78a of printed circuit board 78. Each terminal includes a flexible contact arm 37b having a contact portion 37c exposed within receptacle 32 for engaging a respective one of the exposed conductors 48 (FIG. 6) on FFC 30. Each terminal includes a body portion 37d fixed within the respective terminal-receiving passage 82.

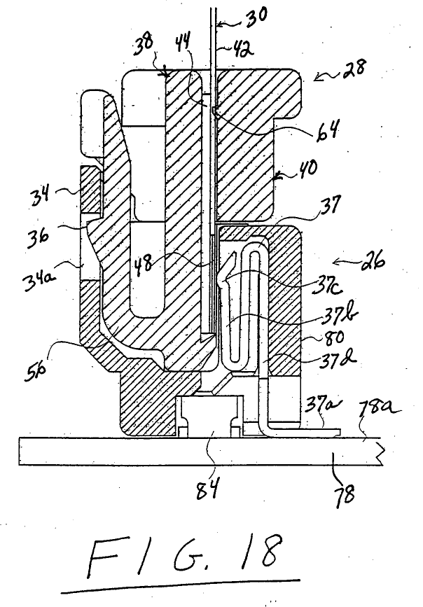

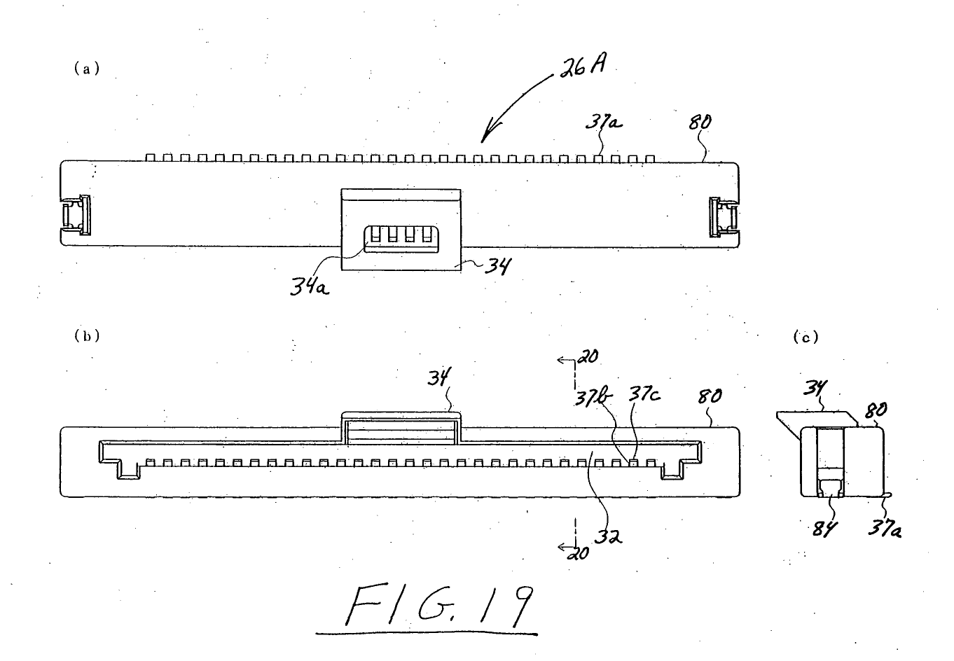

FIG. 17 shows cable holder 28 and FFC 30 about to be inserted in the direction of arrow “A” into receptacle 32 of connector 26. FIG. 18 shows the holder and FFC fully inserted into the connector. It can be seen in FIG. 18 that exposed conductors 48 of the FFC are into engagement with contact portions 37c of terminals 37, as contact arms 37b of the terminals are flexed, whereby the contact portions are biased against the exposed terminals. The terminals electrically connect conductors 48 of the FFC to the circuit traces on surface 78a of printed circuit board 78. When the cable holder is fully inserted into the connector, latch boss 36 on flexible latch arm 56 of gripping member 38 of holder 28 “snaps” into latch aperture 34a of latch 34 on connector 26 to give an audible and/or tactile indication that the holder and the FFC have been fully inserted into the connector.

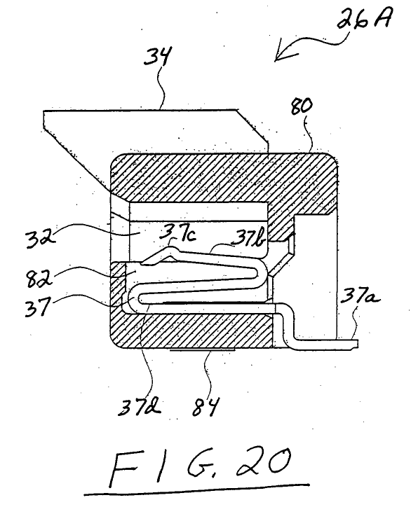

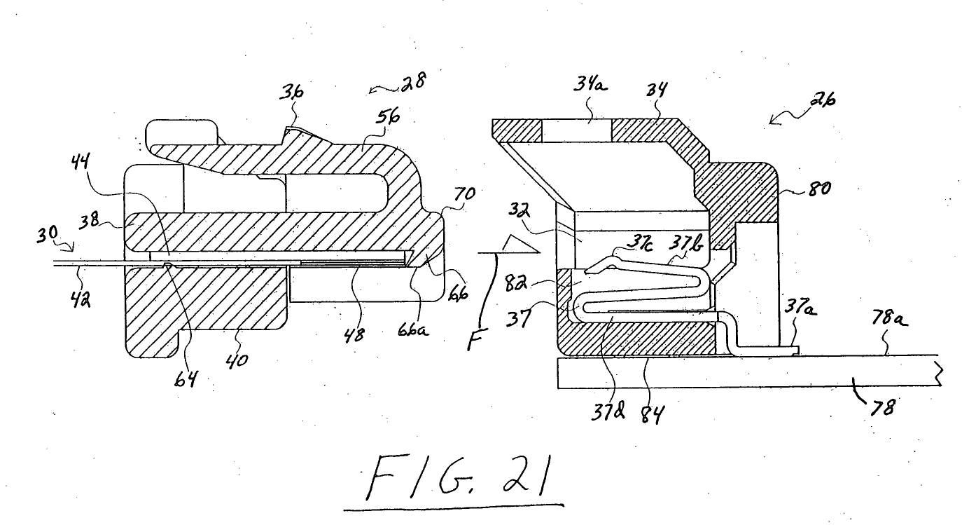

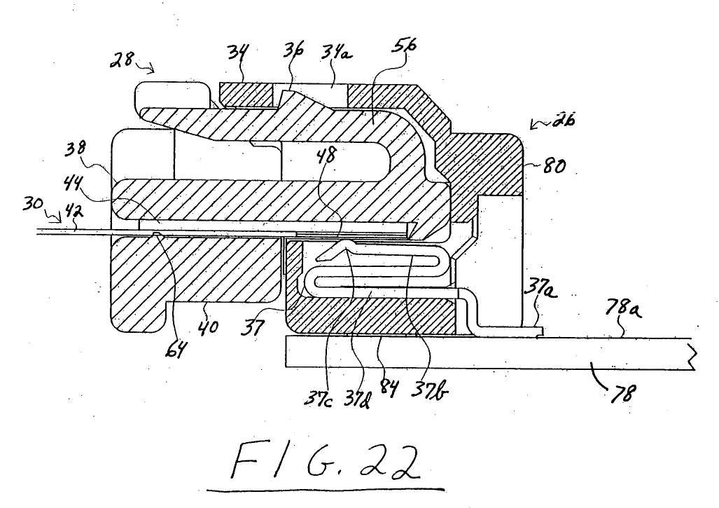

FIGS. 19-22 show a second embodiment of a connector, generally designated 26A, for receiving cable holder 28 and FFC 30. Like reference numerals have been applied in FIGS. 19-22 to designated like components described above in relation to the first embodiment of FIGS. 1-18. Descriptions of those like components will not be repeated. The basic difference between connector 26A according to the second embodiment versus connector 26 according to the first embodiment is the orientation of connector 26A in relation to printed circuit board 78. In the first embodiment, connector 26 was oriented so that cable holder 28 and FFC 30 were inserted into the connector in a vertical direction as viewed in the drawings, i.e., generally perpendicular to the printed circuit board. In the second embodiment of FIGS. 19-22, connector 26A is configured so that receptacle 32 receives cable holder 28 and FFC 30 in a horizontal direction as viewed in the drawings, i.e., generally parallel to printed circuit board 78 as indicated by arrow “F” in FIG. 21. Otherwise, the interengagement and functioning between the cable holder, the FFC and connector 26A is the same as described above in relation to the first embodiment.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A holder for attachment to a distal end portion of a flat flexible cable (FFC) and directly engaging exposed conductors of the FFC with appropriate terminals of a mating connector, the FFC having opposite side edges with tabs extending outwardly from the side edges and opposite flat surfaces between the side edges, comprising:
a pair of interengaging gripping members for gripping the opposite flat surfaces of the FFC between the opposite side edges thereof;
latch means on at least one of the gripping members for latching the holder to the mating connector with the exposed conductors of the FFC in direct engagement with the terminals of the mating connector; and
at least one of the gripping members including side wings extending laterally from each side of the one gripping member and positioning means for properly positioning the distal end portion of the FFC in the holder, said positioning means comprising a positioning post on the side wing of the one gripping member for insertion into a positioning hole in the tab of the FFC, and the other of said gripping members including a positioning hole for accommodating the positioning post of the one gripping member.

2. (canceled)

3. (canceled)

4. The holder of claim 1, including a pair of said positioning posts laterally spaced for insertion into a pair of said positioning holes near the opposite side edges of the FFC.

5. (canceled)

6. The holder of claim 1 wherein at least one of the gripping members includes a plurality of gripping projections in an array extending between the opposite side edges of the FFC and grippingly engageable with one flat surface of the FFC.

7. The holder of claim 6 wherein the other of said gripping members includes a flat face engageable with the other flat surface of the FFC behind said gripping projections.

8. The holder of claim 1, including interengaging latch means between the two gripping members to hold the gripping members against the opposite flat surfaces of the FFC.

9. The holder of claim 8 wherein said interengaging latch means comprise snap-latch means for automatically latching the gripping members together by pressing the gripping members against the opposite flat surfaces of the FFC.

10. The holder of claim I wherein the distal end portion of the FFC has a leading edge, and one of the gripping members includes a lip extending over the leading edge to protect the leading edge.

11. A holder for attachment to a distal end portion of a flat flexible cable (FFC) and directly engaging exposed conductors of the FFC with appropriate terminals of a mating connector, the FFC having opposite side edges with tabs extending outwardly from the side edges and opposite flat surfaces between the side edges, comprising:
a pair of interengaging gripping members for gripping the opposite flat surfaces of the FFC between the opposite side edges thereof, at least one of the gripping members including side wings extending laterally from each side of the one gripping member and positioning means for properly positioning the distal end portion of the FFC in the holder;
said positioning means comprising a positioning post on the side wing of the one gripping member for insertion into a positioning hole in the tab of the FFC and the other of said gripping members including a positioning hole for accommodating the positioning post of the one gripping member
interengaging first latch means between the two gripping members to hold the gripping members against the opposite flat surfaces of the FFC; and
second latch means on at least one of the gripping members for latching the holder to the mating connector with the exposed conductors of the FFC in direct engagement with the terminals of the mating connector.

12. (canceled)

13. The holder of claim 11, including a pair of said positioning posts laterally spaced for insertion into a pair of said positioning holes near the opposite side edges of the FFC.

14. (canceled)

15. The holder of claim 11 wherein at least one of the gripping members includes a plurality of gripping projections in an array extending between the opposite side edges of the FFC and grippingly engageable with one flat surface of the FFC.

16. The holder of claim 15 wherein the other of said gripping members includes a flat face engageable with the other flat surface of the FFC behind said gripping projections.

17. The holder of claim 11 wherein said first interengaging latch means comprise snap-latch means for automatically latching the gripping members together by pressing the gripping members against the opposite flat surfaces of the FFC.

18. The holder of claim 11 wherein the distal end portion of the FFC has a leading edge, and one of the gripping members includes a lip extending over the leading edge to protect the leading edge.

19-28. (canceled)
